(19) United States
(12) Patent Application Publication
(10) Pub. No.: US 2009/0133270 A1
(43) Pub. Date: May 28, 2009

(54) Cutting Apparatus

(76) Inventor: Lee-Cheng Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/049,438

(22) Filed: Mar. 17, 2008

(30) Foreign Application Priority Data
Nov. 28, 2007 (TW) 96145126

(51) Int. Cl. B23D 47/08

(52) U.S. Cl. 30/390; 30/276

(57) ABSTRACT

A cutting apparatus includes a body defining a wall having a groove in which mounted the driving mechanism, which is provided for driving a cutter and includes a fixture mounted thereon for connecting a safeguard and a position adjusting mechanism connected thereto for operably adjusting positions of the driving mechanism in the groove. An adjustable retaining member which selectively moves on the fixture in a first position for retaining the safeguard in the space and a second position for allowing removal of the safeguard.

### BACKGROUND OF INVENTION

1. Field of Invention

The present invention relates to a cutting apparatus, in particular to a cutting apparatus that is adapted to adjust a cutting blade installed thereon, and with the apparatus having a safeguard which is easy installed and moveable in responsive to movement of the cutting blade.

2. Related Prior Art

A cutting apparatus usually has a safeguard for the purpose of prevention from injury. As an example, Taiwan Patent No. M244989 discloses an engaging structure for a protecting shield of a table saw machine 100. The disclosure teaches a panel 22 for joining a protecting shield 21 to a work table 102 of a table saw machine 100. A block 23 is threadly mounted to the panel and the block 23 has a hole in which a fastener 30 can be inserted. The fastener 30 can thereafter be threadly inserted in a compartment 10 for securing the panel 22 to the work table 102 of the table saw machine 100.

A disadvantage to this arrangement is that the protecting shield 21 is not suitable for incorporation on a cutting apparatus that is adapted to adjust a cutting blade installed thereon. Furthermore, a user can not uninstall the protecting shield 21 from the table saw machine 100 without disadvantageous unbolting process.

The present invention is therefore intended to obviate or at least alleviate the problems encountered in prior art.

### SUMMARY OF INVENTION

It is therefore an object of the present invention to provide a cutting apparatus that is adapted to adjust a cutting blade installed thereon, and the apparatus has a safeguard which is easy installed and moveable in responsive to movement of the cutting blade.

Accordingly, the present invention provides a cutting apparatus including a body defining a wall having a groove in which mounted the driving mechanism, which is provided for driving a cutter and includes a fixture mounted thereon for connecting a safeguard and a position adjusting mechanism connected thereto for operably adjusting positions of the driving mechanism in the groove.

The fixture is mounted to the driving mechanism in a manner that moves with the driving mechanism. The fixture also defines a space removably receiving the safeguard.

The invention further includes an adjustable retaining member selectively moveable on the fixture in a first position for retaining the safeguard in the space and a second position for allowing removal of the safeguard.

An advantage of the present invention is that the cutter can be adjusted to various positions.

Another advantage of the present invention is that safeguard moves with the cutter.

A further advantage of the present invention is that the safeguard can be easily installed and removed.

Other advantages, objectives and features of the present invention will become apparent from the following description referring to the attached drawings.

### BRIEF DESCRIPTION OF DRAWINGS

FIG. 1 is a perspective view of a cutting apparatus embodying the present invention.

FIG. 2 is an exploded view of the apparatus of FIG. 1.

FIG. 3 is a side view of the apparatus of FIG. 1.

FIG. 4 is a cross-sectional view taken along line 4-4 in FIG. 3

FIG. 5 is a partial, enlarged view of FIG. 4.

FIGS. 6-7 are similar to FIG. 5 but showing the operation for uninstalling a safeguard of the apparatus.

FIG. 8 is similar to FIG. 5 but showing the safeguard with different thickness.

FIG. 9 is cross-sectional view taken along line 9-9 in FIG. 4.

FIG. 10 is similar to FIG. 9 but showing the operation of a position adjusting mechanism of the apparatus.

FIG. 11 is a side view of the apparatus of FIG. 10.

### DETAILED DESCRIPTION OF THE PREFERRED EMBODIMENT

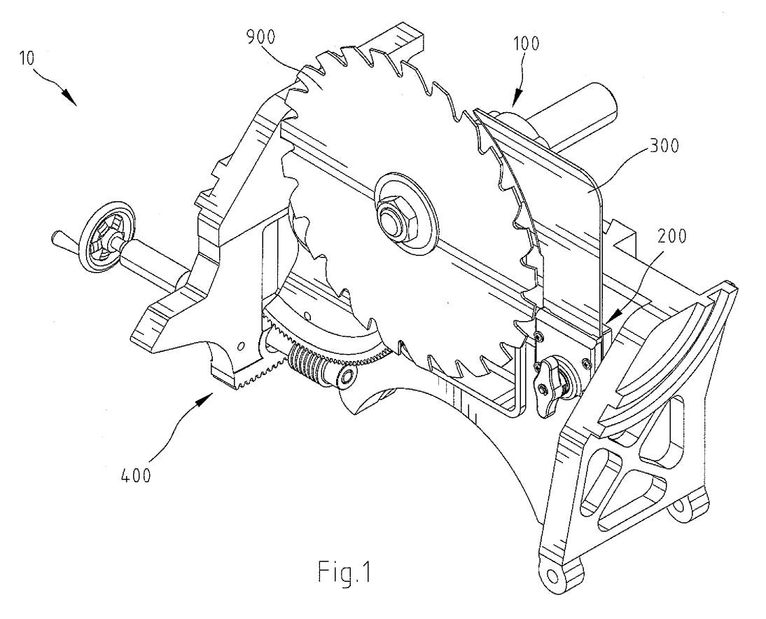

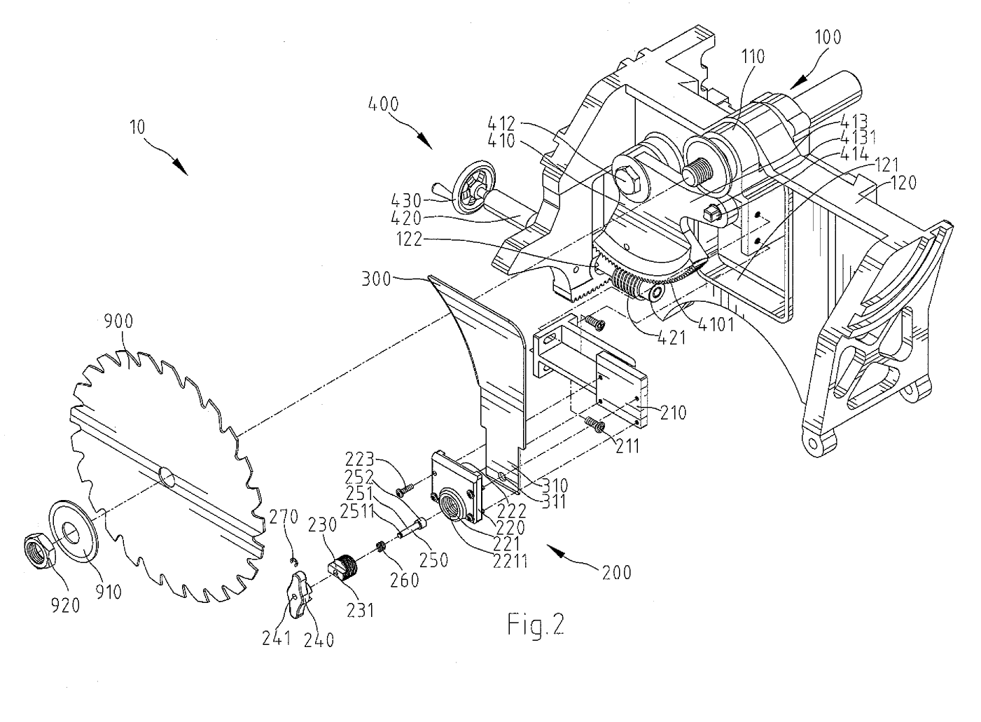

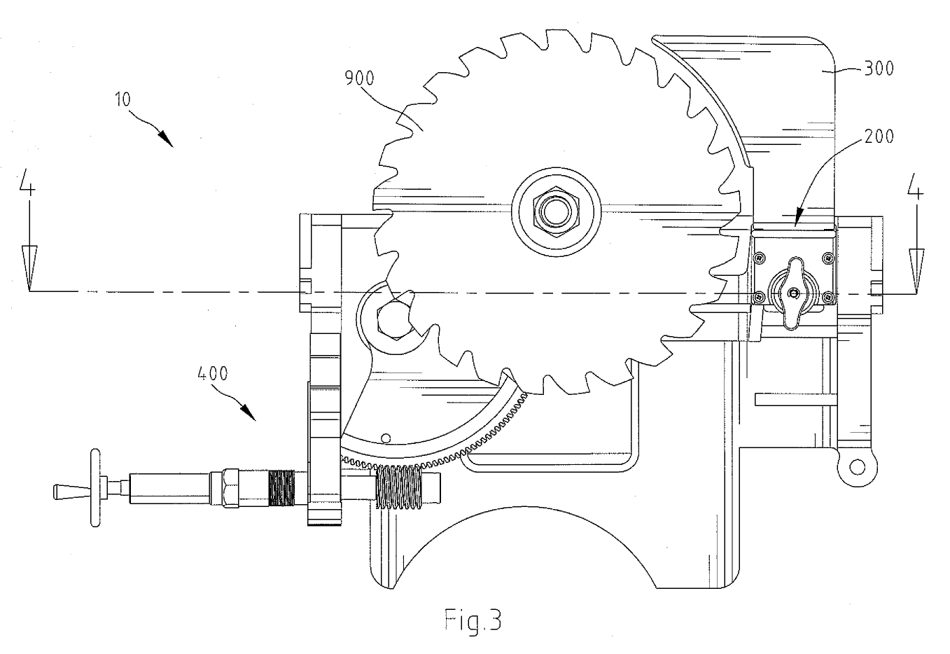

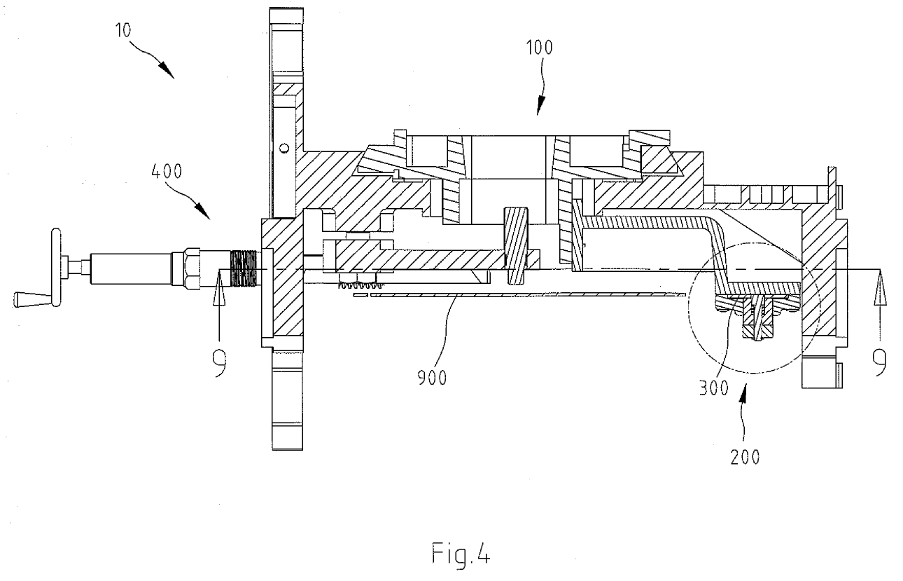

Referring to FIGS. 1 through 5, a cutting apparatus 10 includes a driving mechanism 10 for driving a cutter 900. The cutter 900 is prevented from disengagement from the driving mechanism 10 by a fastener 920. In order to prevent the fastener 920 gradually fret the cutter 900, a spacer 910 may be disposed between the cutter 900 and the fastener 920.

A body 120 defining a first wall having a groove 121 in which mounted the driving mechanism 100, which includes a fixture 200 mounted thereon for connecting a safeguard 300 and a position adjusting mechanism 400 connected thereto for operably adjusting positions of the driving mechanism 100 in the groove 121.

The fixture 200 includes a first fixing member 210 fastened to the driving mechanism 10 by fasteners 211 and the first fixing member 210 includes a planar surface on which mounted a second fixing member 220, which are secured to the first fixing member 210 by fasteners 223 and includes a hole 221 with an inner thread 2211 extending therethrough to communicate with a recess 222, which defines a space 280 between the first and second fixing members 210, 220 adapted to accommodate an engaging end 310 of the safeguard 300.

The engaging end 310 of the safeguard 300 further includes an aperture 311 in which a shaft 250 can selectively engage, particularly, a second end 252 of the shaft 250, which is substantially equal to the size of the aperture 311. The shaft 250 has a first end 251 extended from the second end 252 and having a diameter less than that of the second end 252. The first end 251 further has an indentation 2511 transverse to the extending direction thereof and disposed circumferentially.

The first end of the shaft 250 on which a resilient member 260 can be mounted and the shaft 250 is disposed in an adjustable retaining member 230, which is moveable in the hole 221 of the second fixing member 220 and includes an orifice 231 partially receiving the first end 251 of the shaft 250 and a compartment 232 receiving the resilient member 260. In this preferred embodiment, the adjustable retaining member 230 has a thread section compatible to the inner thread 2211 of the hole 221 such that the adjustable retaining member 230 is threadly moveable in the hole 221.

The first end 251 of the shaft 250 is also adapted to connect to a handle 240, which is connectable to the adjustable retaining member 230 and includes an orifice 241 partially receiving the first end 251 of the shaft 250. In addition, the indentation 2511 is disposed outside the handle 240 and a clip 270 is receivable in the indentation 2511 in order to prevent disengagement of the handle 240 from the adjustable retaining member 230.

Preferably, the handle 240 is provided for facilitating manipulation of the adjustable retaining member 230 and, thus, may be omitted.

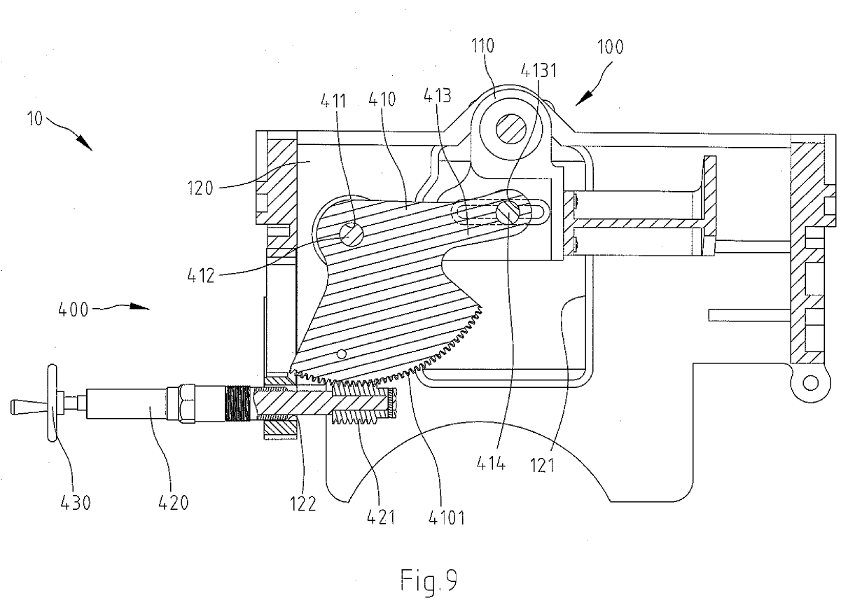

Turning now to FIG. 9, the position adjusting mechanism 400 includes a fanwise gear 410 which is pivotally connected to the body 120 and has a hole 411 located substantially with equal distances to the arcuate gear section 4101 of the fanwise gear 410 and in which a fastener 412 can be received. The fastener 412 prevents disengagement of the fanwise gear 410 from the body 120. The fanwise gear 410 further includes an integrally formed arm 413 extended therefrom, but not from the arcuate gear section 4101. The arm 413 extends in a plane that is parallel to a plane of extension from the hole 410 to the arcuate gear section 4101. Preferably, the arm 413 extends from where the hole 411 locates. The arm 413 is connected to the driving mechanism 10 and includes an orifice 4131 in which a connector 414 can be received. The connector 414 prevents disengagement of the arm 413 from the driving mechanism 10. Additionally, the connector 414 is moveably disposed in an elongated slot 110 defined by the driving mechanism 10 as the fanwise gear 410 pivots.

In this preferred embodiment, the fanwise gear 410 is pivoted via a spindle 420. The spindle 420 is partially received in a hole 122 defined in a second wall of the body 120. The second wall is in a perpendicular relation with the first wall. The spindle 420 includes an outer thread 421 engaged with the arcuate gear section 4101 of the fanwise gear 410. Preferably, the outer thread 421 has a number of gears less than a number of gears of the arcuate gear section 4101. The spindle 420 also includes a crank handle 430 that a user can use to turn the spindle 420. Preferably, the crank handle 430 and the outer thread 421 are disposed at different sides of the spindle 420 with respect to the hole 122 of the body 120.

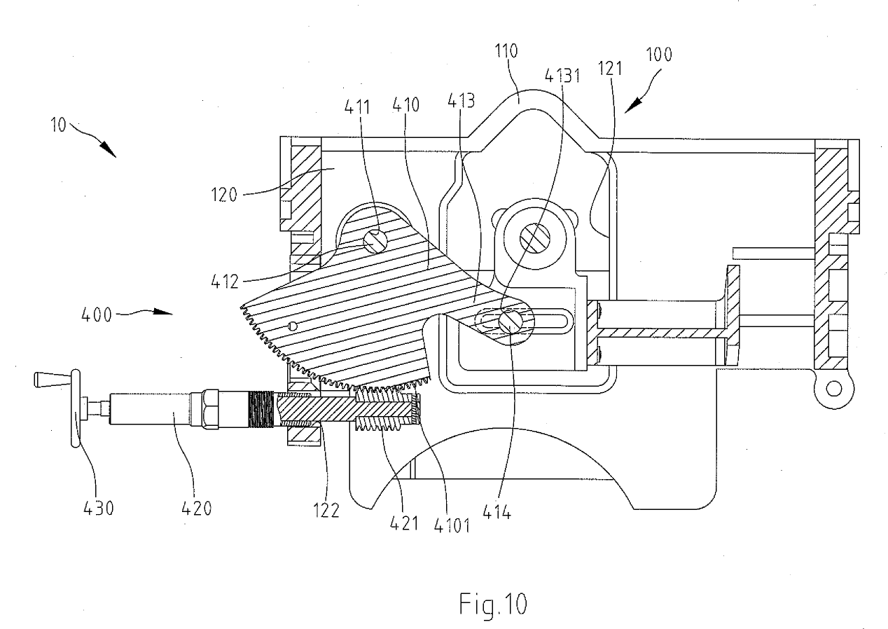

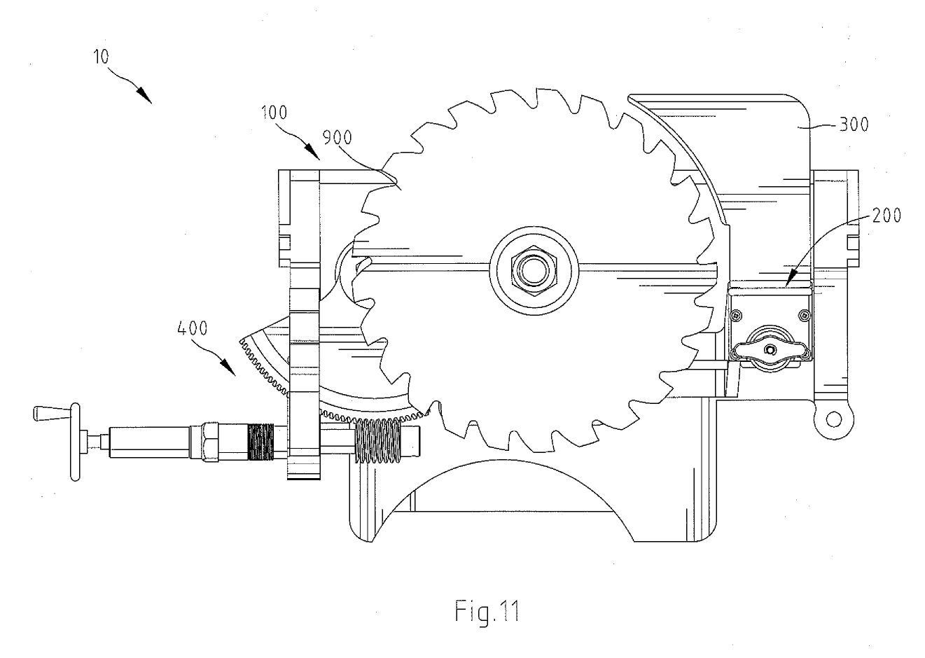

Turning now to FIGS. 9 and 10, as the crank handle 430 is turned, the gears of the outer thread 421 of the spindle 420 will be turned to engage with different gears of the arcuate gear section 4101 of the fanwise gear 410. As such, the fanwise gear 410 is caused to pivot with respect to the fastener 412, then, the connector 414 will be caused to be moveable in the slot 110 and the driving mechanism 10 is operably adjusted in the groove 121. Moreover, the spindle 412 will be caused to move linearly in the hole 122. Also, the safeguard 300 and the cutter 900 are moved with respect to the driving mechanism 10.

The safeguard 300 is disposed in the space 280 and securely retained between the edge end of the adjustable retaining member 230 and the planar surface of the first fixing member 210. Also, the aperture 311 of the engaging end 310 of the safeguard 300 is inserted by the second end 252 of the shaft 250 so that the adjustable retaining member 230 can be effectively retained in the space 280.

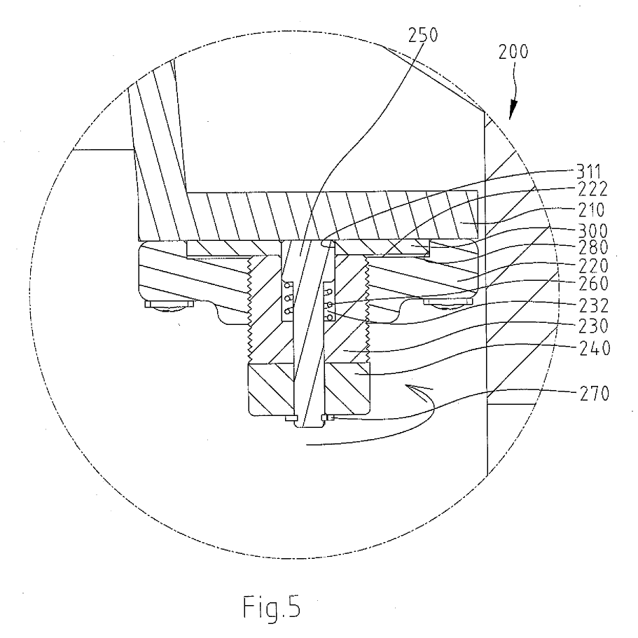

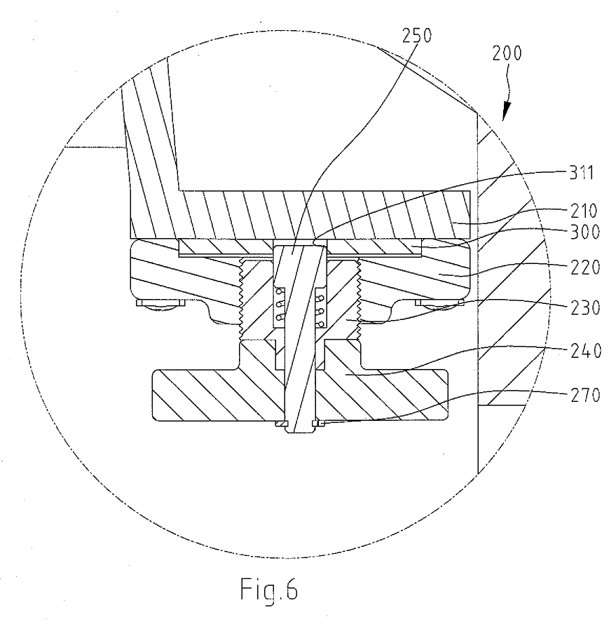

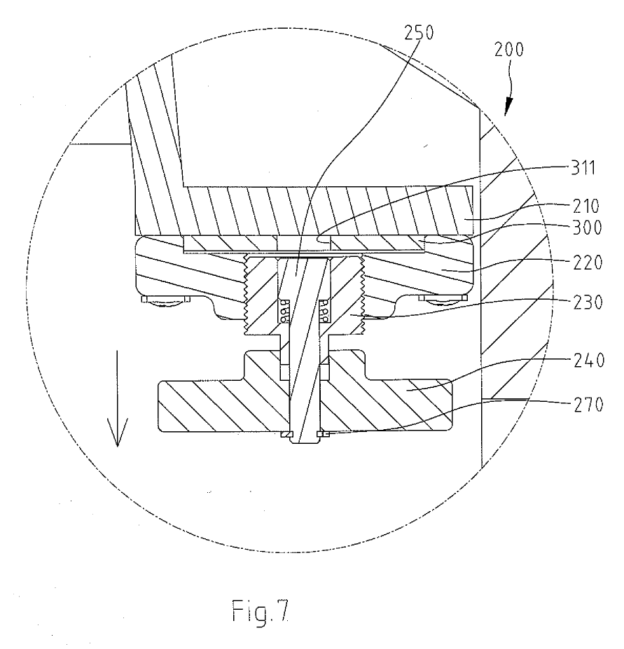

Turning now to FIGS. 5-7, if the safeguard 300 is to be uninstalled from the fixture 200, the adjustable retaining member 230 is moved outboard from the hole 221 of the second fixing member 220 of the fixture 200. In this case, the adjustable retaining member 230 is turned. As the adjustable retaining member 230 is turned outboard, the end edge of the adjustable retaining member 230 will no longer be in contact with the safeguard 300 and the second end 252 of the shaft 250 will gradually be moved out to disengage the aperture 311. Thus, the safeguard 300 can be removed. The removal of the safeguard 300 can also be done by first moving the adjustable retaining member 230 outboard from the hole 221 of the second fixing member 220 and then pulling the shaft 250 outboard. Accordingly, the second end 252 of the shaft 250 disengages the aperture 311 and moves further into the compartment 232 of the adjustable retaining member 230.

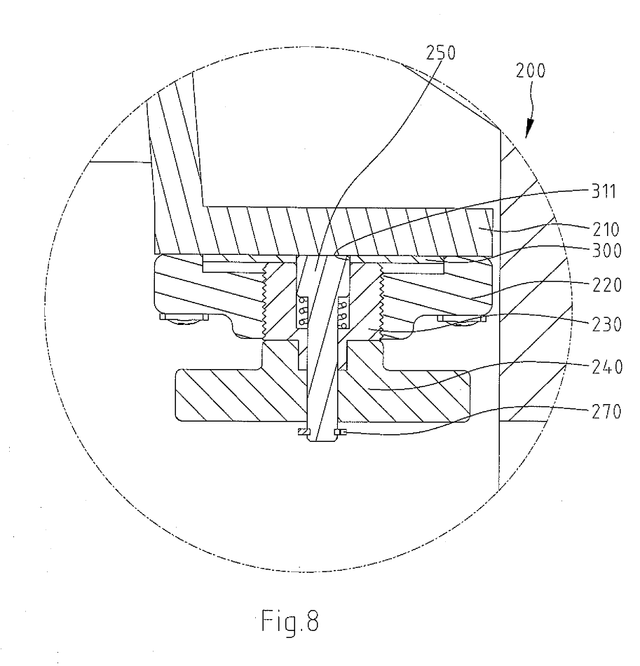

Referring to FIG. 8, various thickness of engaging end 310 of the safeguard can be retained between the edge end of the adjustable retaining member 230 and the planar surface of the first fixing member 210 provided if the thickness is within that of the space 280.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cutting apparatus comprising:
a body;
a driving mechanism for driving a cutter moveably mounted to the body;
a fixture, mounted to the driving mechanism in a manner that moves with the driving mechanism and defines a space;
a safeguard, removably received in the space and being moveable with the fixture;
an adjustable retaining member selectively moveable on the fixture in a first position for retaining the safeguard in the space and a second position for allowing removal of the safeguard.

2. The cutting apparatus according to claim 1 further comprising a position adjusting mechanism including a fanwise gear pivotally mounted to the body, an arm extending from the fanwise gear connected to the driving mechanism, and a spindle for rendering pivotal movement of the fanwise gear.

3. The cutting apparatus according to claim 2 wherein the fanwise gear comprises an arcuate gear section, and wherein the spindle comprises an outer thread engagable with the arcuate gear section.

4. The cutting apparatus according to claim 2 wherein the driving mechanism comprises a slot, and wherein the arm comprises a connector received, and the connector being moveably disposed in the slot.

5. The cutting apparatus according to claim 3 wherein the fanwise gear comprises a hole, and wherein the arm extends from the fanwise gear in a plane that is parallel to a plane extending from the hole to the arcuate gear section.

6. The cutting apparatus according to claim 5 wherein the hole is receivable with a fastener that prevents disengagement of the fanwise gear from the body, and wherein the hole is distanced substantially at equal distances from the arcuate gear section.

7. The cutting apparatus according to claim 3 wherein the outer thread has a number of gears less than a number of gears of the arcuate gear section.

8. The cutting apparatus according to claim 7 further comprising a crank handle attached thereon for turning the outer thread.

9. The cutting apparatus according to claim 2 wherein the body comprises a groove, and wherein the driving mechanism is moveable in the groove by the position adjusting mechanism.

10. The cutting apparatus according to claim 1 wherein the fixture comprises a first fixing member having a planar surface, a second fixing member mounted to the first fixing member having a recess, and with the space being defined by the planar surface and the recess.

11. The adapter according to claim 10 wherein the second fixing member comprises a hole communicating with the recess, and wherein the adjustable retaining member can moveably engaged in the hole.

12. The cutting apparatus according to claim 11 further comprising a shaft having a first end and a second end, with the first end having a diameter less than that of the second end, and with the first end having an indentation and a resilient member thereon.

13. The cutting apparatus according to claim 12 wherein the adjustable retaining member comprises an orifice for partially receiving the first end of the shaft and a compartment for receiving the resilient member.

14. The cutting apparatus according to claim 13 further comprising a handle connectable to the adjustable retaining member and wherein the first end of the shaft is partially disposed in the handle.

15. The cutting apparatus according to claim 12 wherein the indentation is exposed out of the adjustable retaining member and includes a clip received therein.

16. The cutting apparatus according to claim 14 wherein the indentation is exposed out of the adjustable retaining member and includes a clip received therein.

17. The cutting apparatus according to claim 12 wherein the safeguard comprises an aperture the second end of the shaft can selectively engage.
